(19) United States
(12) Patent Application Publication
(10) Pub. No.: US 2025/0184728 A1
(43) Pub. Date: Jun. 5, 2025

(54) SYSTEM AND METHOD FOR TWO-FACTOR AUTHENTICATION AT AN ACCESS CONTROL POINT THAT IS NOT CONNECTED TO A NETWORK

(71) Applicant: MOTOROLA SOLUTIONS, INC., CHICAGO, IL (US)

(72) Inventors: GRZEGORZ GUSTOF, MYSLENICE (PL); KRZYSZTOF MINIOR, RUDAWA (PL); RAFAL KOSCIEJ, SIEMIANOWCIE ISKIE (PL)

(21) Appl. No.: 18/524,368

(22) Filed: Nov. 30, 2023

(51) Int. Cl. H04W 12/06

(52) U.S. Cl. CPC H04W 12/06

(57) ABSTRACT

Techniques for two factor authentication are provided. An access control point that is not connected to a network receives an encoded encrypted access credential that includes a biometric factor and an access token. The encoded encrypted access credential is decoded to extract a signed encrypted access credential. The signed encrypted access credential is decrypted at the access control point using a private key to create a signed decrypted access credential. The signed decrypted access credential is validated at the access control point. The biometric factor and the access token are extracted from the signed decrypted access credential. A user provided biometric factor is received. The user provided biometric factor is compared with the extracted biometric factor. Access via the access control point is provided when the comparing indicates the user provided biometric factor and the extracted biometric factor are the same and the access token indicates access should be allowed.

### BACKGROUND

The use of two-factor authentication is becoming increasingly prevalent. In the past, authentication may have been performed using a simple password (e.g. something you know, etc.). Although such a mechanism is workable, it is susceptible to failure. For example, a password could be stolen. In order to enhance security, two-factor authentication may be required. The second factor may include use of an access token, for example a device like an ID badge (e.g. something you have, etc.) or a biometric factor, such as a fingerprint reader or iris scanner (e.g. something you are, etc.)

An example of where such two-factor authentication may be implemented is at an access control point consisting of a door. A user may be required to provide an access token (e.g. a badge, etc.) to prove to the system that they have the proper privileges to traverse the door. The access control point may also obtain a biometric factor (e.g. fingerprint, etc.) from the user in order for the user to prove that they are actually the person to who the access token was provided. The access control point may then, via a network, send the access token and biometric factor to an access control system. The access control system determines if the person should be granted access via the access control point.

The access control system may receive the access token and determine if the person associated with the access token should be allowed access via the access control point. If the person should be allowed access, a stored biometric factor associated with the person to whom the access token was issued is retrieved. The access control system may then compare the retrieved biometric factor with the biometric factor received from the access control point. If the two biometric factors are the same, the access control system is able to authenticate the user via two factors (e.g. the access control token and the biometric factor). The access control system may then send an indication, via a network, to the access control point indicating that the user should be allowed to traverse the access control point. For example, the door controlled by the access control point may be electronically unlocked.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 is an example of an administrative server that may be used to generate an encoded encrypted access credential for a user according to the techniques described herein.

FIG. 2 is an example of an access control point that is not connected to a network using an encoded encrypted access credential to perform two-factor authentication for a user according to techniques described herein.

FIG. 3 is an example flow diagram for an access control point that provides two-factor authentication for a user via an encoded encrypted access credential while not being connected to a network.

FIG. 4 is an example flow diagram of an administrative server creating an encoded encrypted access credential.

FIG. 5 is an example of a device that may implement the access control point and/or the administrative server.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The system, apparatus, and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF THE INVENTION

The two-factor authentication system described above is suitable for use when there is a network connection between the access control point and the access control system that allows the two to communicate. A problem arises when the access control point is not connected to a network and therefore cannot communicate with the access control system. For example, the access control point may receive the biometric factor and access token, but has no way to communicate this information to the access control system. As such, the access control system cannot verify the biometric factor and access token. The access control system further cannot send an indication to the access control point to allow the user to traverse the access control point.

There are many situations where an access control point may not have a network connection to an access control server. For example, consider an access control point that is a door to an air gapped system (e.g. military base, government secure facility, etc.). An air gapped system may not allow any connections to any type of network that allows communications outside of the building. If the access control system is not located within the building, a connection from the access control point to the access control system will not be allowed.

As yet another example, the access control point may be located somewhere where there is no network connectivity available. For example, consider a short-term rental cabin in the woods where there is no network connectivity (e.g. cellular dead zone, etc.). It is not possible for there to be communications between the access control point and the access control system because there is simply no network coverage in such a situation.

As yet another example, there could be periods of network outages, wherein the access control point and the access control system are unable to communicate. During this period, it would be impossible to allow anyone access via the access control point. In cases of disasters, there may be long lasting network outages. In some cases, this may be exactly when access to people may need to be granted (e.g. access to first responders addressing the disaster, etc.).

One possible solution to the problems described above is to allow the access control point to locally store information related to the access tokens and biometric factors, such that communication with the access control system is no longer required. Such solutions have several shortcomings. For example, in the case of air gapped systems or where there is absolutely no network connectivity available, getting the access token and biometric factors into the access control point would require someone to physically go to the access control point to load the information into the access control point manually. In the case of the temporary network outage, new users could not be added to the access control point until the network connection is resumed.

The techniques described herein solve these problems individually and collectively. A trusted administrative server associated with the access control system is used to generate an access credential that includes an access token as well as a biometric factor. The access credential is generated in such a way that any tampering of the access credential is easily detected. Furthermore, the access credential is encrypted such that only a specific access control point is able to decrypt the access credential. The access credential is then provided to a user who needs to be given access via the access control point.

At the access control point, the user may present the access credential. The access control point may then extract the access token and the biometric factor from the access credential. As mentioned above, the administrative server creates the access credential in such a way that the specific access control point is the only access control point that can extract the access token and the biometric factor. The access control point may also determine if the access credential has been tampered with. The access control point may then receive a biometric factor from the user and compare to the extracted biometric factor. If they are the same and the access token indicates access should be granted, the access control point may grant the user access via the access control point.

A method for two-factor authentication is provided. The method includes receiving, at an access control point that is not connected to a network, from a user, an encoded encrypted access credential, the encoded encrypted access credential including a biometric factor of the user and an access token. The method further includes decoding, at the access control point, the encoded encrypted access credential to extract a signed encrypted access credential. The method further includes decrypting, at the access control point, the signed encrypted access credential using a private key associated with the access control point, to create a signed decrypted access credential. The method further includes validating, at the access control point, that the signed decrypted access credential was created by a trusted administrative server by verifying the signed decrypted access credential was signed with a credential associated with the trusted administrative server. The method further includes extracting, at the access control point, the biometric factor and the access token from the signed decrypted access credential. The method further includes receiving, at the access control point, a user provided biometric factor. The method further includes comparing, at the access control point, the user provided biometric factor with the extracted biometric factor. The method further includes providing access via the access control point when the comparing indicates the user provided biometric factor and the extracted biometric factor are the same and the access token indicates access should be allowed.

In one aspect, the method further includes receiving, at the trusted administrative server, the user provided biometric factor, receiving, at the trusted administrative server, the access token, the access token indicating conditions under which the user is allowed access via the access control point, combining, at the trusted administrative server, the user provided biometric factor and the access token to create a unencrypted access credential, signing, at the trusted administrative server, the unencrypted access credential with a credential associated with the trusted administrative server to create a signed unencrypted access credential, encrypting, at the trusted administrative server, the signed unencrypted access credential with a public key associated with the access control point to create the signed encrypted access credential, generating the encoded encrypted access credential by encoding the signed encrypted access credential, and providing the encoded encrypted access credential to the user.

A system for two factor authentication is provided. The system comprises a processor and a memory coupled to the processor. The memory contains a set of instructions thereon that when execute by the processor cause the processor to receive, at an access control point that is not connected to a network, from a user, an encoded encrypted access credential, the encoded encrypted access credential including a biometric factor of the user and an access token. The instructions further cause the processor to decode, at the access control point, the encoded encrypted access credential to extract a signed encrypted access credential. The instructions further cause the processor to decrypt, at the access control point, the signed encrypted access credential using a private key associated with the access control point, to create a signed decrypted access credential. The instructions further cause the processor to validate, at the access control point, that the signed decrypted access credential was created by a trusted administrative server by verifying the signed decrypted access credential was signed with a credential associated with the trusted administrative server. The instructions further cause the processor to extract, at the access control point, the biometric factor and the access token from the signed decrypted access credential. The instructions further cause the processor to receive, at the access control point, a user provided biometric factor. The instructions further cause the processor to compare, at the access control point, the user provided biometric factor with the extracted biometric factor. The instructions further cause the processor to provide access via the access control point when the comparing indicates the user provided biometric factor and the extracted biometric factor are the same and the access token indicates access should be allowed.

In one aspect, the instructions further cause the processor to receive, at the trusted administrative server, the user provided biometric factor, receive, at the trusted administrative server, the access token, the access token indicating conditions under which the user is allowed access via the access control point, combine, at the trusted administrative server, the user provided biometric factor and the access token to create a unencrypted access credential, sign, at the trusted administrative server, the unencrypted access credential with a credential associated with the trusted administrative server to create a signed unencrypted access credential, encrypt, at the trusted administrative server, the signed unencrypted access credential with a public key associated with the access control point to create the signed encrypted access credential, generate the encoded encrypted access credential by encoding the signed encrypted access credential, and provide the encoded encrypted access credential to the user.

A non-transitory processor readable medium containing a set of instructions thereon is provided. The instructions on the medium, that when executed by a processor, cause the processor to receive, at an access control point that is not connected to a network, from a user, an encoded encrypted access credential, the encoded encrypted access credential including a biometric factor of the user and an access token. The instructions on the medium further cause the processor to decode, at the access control point, the encoded encrypted access credential to extract a signed encrypted access credential. The instructions on the medium further cause the processor to decrypt, at the access control point, the signed encrypted access credential using a private key associated with the access control point, to create a signed decrypted access credential. The instructions on the medium further cause the processor to validate, at the access control point, that the signed decrypted access credential was created by a trusted administrative server by verifying the signed decrypted access credential was signed with a credential associated with the trusted administrative server. The instructions on the medium further cause the processor to extract, at the access control point, the biometric factor and the access token from the signed decrypted access credential. The instructions on the medium further cause the processor to receive, at the access control point, a user provided biometric factor. The instructions on the medium further cause the processor to compare, at the access control point, the user provided biometric factor with the extracted biometric factor. The instructions on the medium further cause the processor to provide access via the access control point when the comparing indicates the user provided biometric factor and the extracted biometric factor are the same and the access token indicates access should be allowed.

In one aspect, the instructions on the medium further cause the processor to receive, at the trusted administrative server, the user provided biometric factor, receive, at the trusted administrative server, the access token, the access token indicating conditions under which the user is allowed access via the access control point, combine, at the trusted administrative server, the user provided biometric factor and the access token to create a unencrypted access credential, sign, at the trusted administrative server, the unencrypted access credential with a credential associated with the trusted administrative server to create a signed unencrypted access credential, encrypt, at the trusted administrative server, the signed unencrypted access credential with a public key associated with the access control point to create the signed encrypted access credential, generate the encoded encrypted access credential by encoding the signed encrypted access credential, and provide the encoded encrypted access credential to the user.

In one aspect, the signed unencrypted access credential is created using a digital certificate. In one aspect, the encoded encrypted access credential is a Quick Response (QR) code. In one aspect, the encoded encrypted access credential is stored in a Near Field Communication (NFC) device associated with the user. In one aspect, the biometric factor is facial recognition data. In one aspect, the biometric factor is fingerprint data. In one aspect, the access token includes an expiration date. In one aspect, the access control point is an air gapped system. In one aspect, the access control point provides access control for a short term rental property.

Each of the above-mentioned embodiments will be discussed in more detail below, starting with example environments in which the embodiments may be practiced, followed by an illustration of processing blocks for achieving an improved technical method, device, and system for two-factor authentication at an access control point that is not connected to a network, and concluding with architectures of device(s) which may implement the system.

Further advantages and features consistent with this disclosure will be set forth in the following detailed description, with reference to the figures.

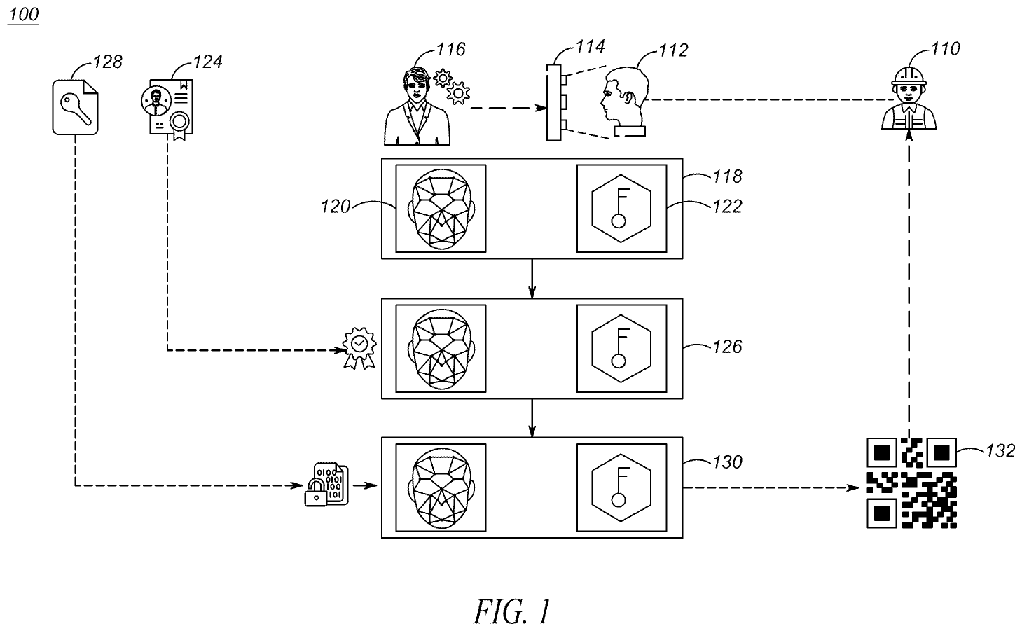

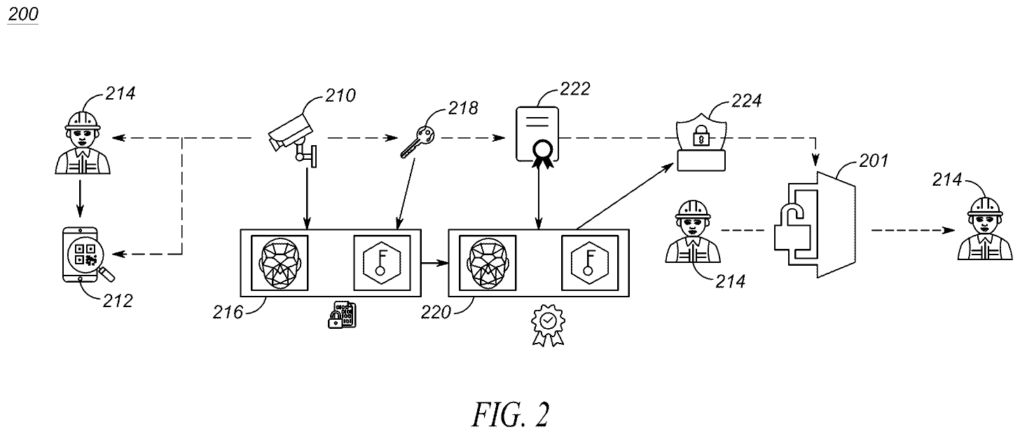

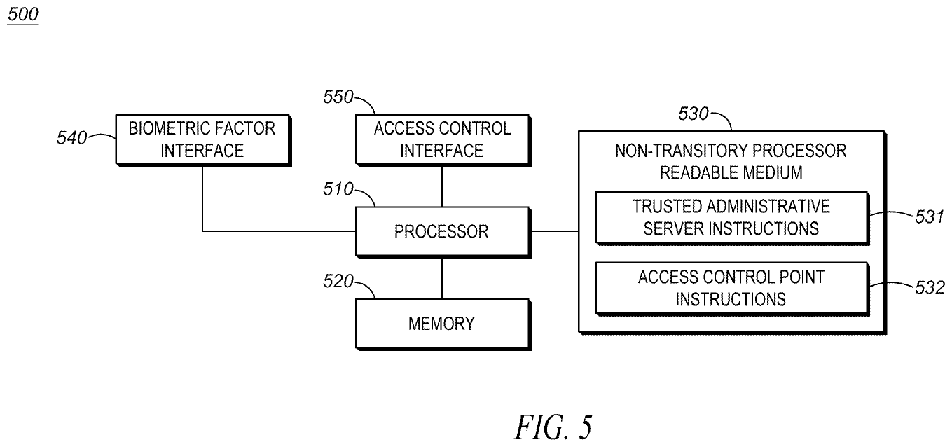

FIG. 1 is an example of functionality provided by a trusted administrative server 100 that may be used to generate an encoded encrypted access credential for a user according to the techniques described herein. A device that may implement this functionality is described with respect to FIG. 5. For purposes of ease of description, FIGS. 1 and 2 will be described in terms of an example use case. For the example use case, consider a user who wishes to rent a cabin in the woods as a short-term rental (e.g. AirBNB™, etc.). The cabin is located in an area where there is no network connectivity, and as such the access control point (e.g. electronic door lock) at the cabin cannot communicate with the access control system. Furthermore, assume that the access control point at the cabin is able to receive an access credential from a user.

FIG. 1 depicts the functions provided by an administrative server. The administrative server functionality may be encompassed in a larger access control system. In order for a user 110 to obtain an access credential, the user first provides a biometric factor 112 to the trusted administrative server 116. For example, the user 110 may utilize a biometric reader 114 to capture the biometric factor.

One common biometric factor may be a facial image to be used later with facial recognition and comparison techniques. The biometric reader 114 in such case may be a camera. Other types of biometric factor may include fingerprint scans, iris scans, palm scans, DNA scans, voice print scans, or any other type of biometric factor. It should be clear that each type of biometric factor may have its own type of reader, and a camera is only one type of biometric factor reader. What should be understood is that any type of biometric factor that falls into the “something you are” category would be suitable for use with the techniques described herein. The techniques described herein are suitable for use with any currently available or later developed biometric factor.

Once the biometric factor has been captured by the biometric factor reader 114, the biometric factor 120 can be stored in an unencrypted access credential 118. The biometric factor can be stored in any format that would usable later to compare the stored biometric factor 120 with a live person presenting the biometric factor. For example, in many facial recognition systems, a facial vector is extracted from an image of a face and it would be the facial vector that is stored in the access credential. What should be understood is that the specific biometric factor information that is stored is relatively unimportant, so long as the biometric factor information can be later used to determine if the same person who created the biometric factor is currently in the presence of an access control point.

The trusted administrative server 116 may then create an access token 122. The access token may indicate when the user 110 is allowed to access the resource protected by the access control point. In the present example of renting a cabin, the access token may include a check-in time/date and a check out time/date. Any attempt to access the cabin before the specified check-in or after the specified check-out will be rejected, regardless of if the biometric factor matches. The access token can then also be included in the unencrypted access credential 118.

It should be understood that the access token 122 is set by the trusted administrative server 116 to reflect when the user should have access. This access is not limited to just check-in/check-out criteria. For example, the access token could specify times of day, days of week, specific dates, specific times, etc. What should be understood is that the access token determines during which times the user 110 should/should not be granted access to the resource (e.g. cabin, etc.) protected by the access control point.

At this point, it should be understood that the unencrypted access credential 118 includes the biometric factor 120 and the access token 122. However, there is nothing to prevent someone from modifying the information included therein. For example, a nefarious actor could attempt to modify the unencrypted access credential by replacing the biometric factor of one person with another. A nefarious actor may also attempt to modify the access token to allow for access by the user 110 outside of the times specified by the access token.

To detect any type of tampering, the trusted administrative server 116 may sign 124 the unencrypted access credential to create a signed unencrypted access credential 126. There are many different ways that the trusted administrative server may sign the unencrypted access credential. In one example, a certificate of the administrative server may be used to sign the unencrypted access credential. The access control point will be equipped with the certificate of the trusted administrative server. If the unencrypted access credential is tampered with in any way, the digital signatures will not match and it will be known that some form of tampering has occurred and that the unencrypted access credential cannot be trusted. The access control point may then reject any attempted access.

In another example, public/private key encryption could be used instead of signing with a certificate. As is well known in public/private key encryption, anything encrypted with a public key can only be decrypted with a corresponding private key and anything encrypted with a private key can only be decrypted with a corresponding public key. The public key can be widely shared, while the private key is known only to the trusted server. In one implementation, the trusted administrative server 116 may encrypt (i.e. sign) the unencrypted access credential 118 with a private key known only to the trusted administrative server. The access control point may be provisioned with the public key corresponding to the private key used by the trusted administrative server. Although the public key associated with the trusted administrative server is widely distributed, if a nefarious actor decrypts the unencrypted access credential and modifies the contents, they will not be able to re-encrypt (i.e. sign) it using the private key of the trusted administrative server, because they do not possess the private key. The access control point would reject any unencrypted access credential 118 that was not properly encrypted (i.e. signed) with the private key associated with the trusted administrative server.

Although two examples are described for creating the signed unencrypted access credential, it should be understood that the techniques described herein are not limited to those particular techniques. Any technique that is able to determine if the unencrypted access credential has been tampered with are suitable for use with the techniques described herein.

The trusted administrative server 116 may then encrypt the signed unencrypted access credential 126 with the public key 128 of the access control point to create a signed encrypted access credential 130. By encrypting the signed unencrypted access credential with the public key of the access control point, this provides an additional level of security, because the signed encrypted access credential may only be decrypted by the access control point that is in possession of the corresponding private key. If each controlled resources (e.g. cabin, etc.) is provisioned with its own private key, the signed encrypted access credential can only be decrypted by the cabin associated with the user's 110 rental. It should be noted that in some implementations symmetric keys, in which the public and private keys are the same, could be used.

It should be noted that although the example presented first signed the unencrypted access credential 124 to create the signed unencrypted access credential 126 and then encrypted 128 the signed unencrypted access credential to create the signed encrypted access credential 130, this ordering is relatively unimportant. The step of encrypting 128 could have been performed first, followed by the step of signing 124. What should be understood is that any order would work, so long as both the trusted administrative server and the access control point follow the same order.

The trusted administrative server 116 may then generate an encoded encrypted access credential 132 by encoding the signed encrypted access credential 130. The particular form of the encoding is unimportant. In the example shown, the encoding is depicted as a Quick Response (QR) code that is provided to a device associated with the user (e.g. user takes a picture with his smart phone, etc.). This example is for purposes of ease of description only. The encoding could be encoding the signed encrypted access credential into a near field communication (NFC) device (e.g. Radio Frequency ID tag), associated with the user's device. What should be understood is that the signed encrypted access credential is provided to the user in such a way that it can be presented to the access control point when attempting to access the protected resource (e.g. the cabin, etc.).

FIG. 2 is an example of an access control point 200 that is not connected to a network using an encoded encrypted access credential to perform two-factor authentication for a user according to techniques described herein. Continuing with the present example of renting a cabin in an area with no network connectivity, the access control point depicted in FIG. 2 could be used to provide access to the cabin.

The access control point 200 may receive an encoded encrypted access credential. For example, in the case where the encoded encrypted access credential is provided as a QR code, a camera 210 could be used to scan the QR code 212 provided by the user 214. For example, the user may display the QR code on a smartphone. Assuming the biometric factor is based on facial recognition, the camera may also capture an image of the user's face. It should be understood that the biometric factor might not necessarily be of a type that can be captured by a camera. For example, a fingerprint or DNA would not be appropriate for capture with a camera. What should be understood is that an appropriate biometric factor reader is provided for whatever type of biometric factor is used.

The encoded encrypted access credential may then be decoded to extract the signed encrypted access credential 216. It should be understood that receiving the encoded encrypted access credential is dependent on how the credential was encoded. For example, if the credential was encoded as part of an NFC tag associated with the user's 214 smartphone, an NFC tag reader (not shown) may be used. The particular technique used to decode the encoded encrypted access credential is unimportant, so long as it is of a type compatible with how the credential was encoded by the trusted administrative server.

The signed encrypted access credential 216 may then be decrypted using a private key 218 associated with the access control point to create a signed decrypted access credential 220. As explained above, the signed encrypted access credential is encrypted with a public key of the access control point 200. As such, only an entity with the private key associated with that public key would be able to decrypt the signed encrypted access credential. A successful decryption indicates that the signed encrypted access credential was indeed intended for this particular access control point (e.g. this particular cabin, etc.).

The signed decrypted access credential 220 may then be validated by the access control point. For example, a certificate 222 associated with the trusted administrative server may be used to validate the signed decrypted access credential. If the validation is successful, this proves that the access credential has not been tampered with and that it was actually provided by the trusted administrative server.

Once validated, the biometric factor and the access token may be extracted 224 from the signed unencrypted access credential 220. Because of the previous steps, the access control point can be assured that the biometric factor and the access token were actually provided by the trusted administrative server and have not been tampered with at any point. The biometric factor can be compared to a biometric factor provided by the user 214 to determine if they match. If they do match, the access token can be examined to determine if the user 214 should be given access. If both conditions are satisfied, the physical access control point 201 may be commanded to allow the user 214 access (e.g. the door of the cabin is unlocked, etc.). Although the access control point has been described as a physical access control point, it should be understood that the techniques described herein could be utilized with any controlled resource. For example, the resource may be a computer, an application on a computer, etc.

What should be noted is that the access control point 200 did not require any form of communication to the access control system/trusted administrative server. The biometric factor and access token were encoded/encrypted/signed in such a way that the access control point is confident that the user has properly been granted access by the trusted administrative server and that the biometric factor has not been compromised between the time it was captured by the trusted administrative server and the time it is extracted by the access control point.

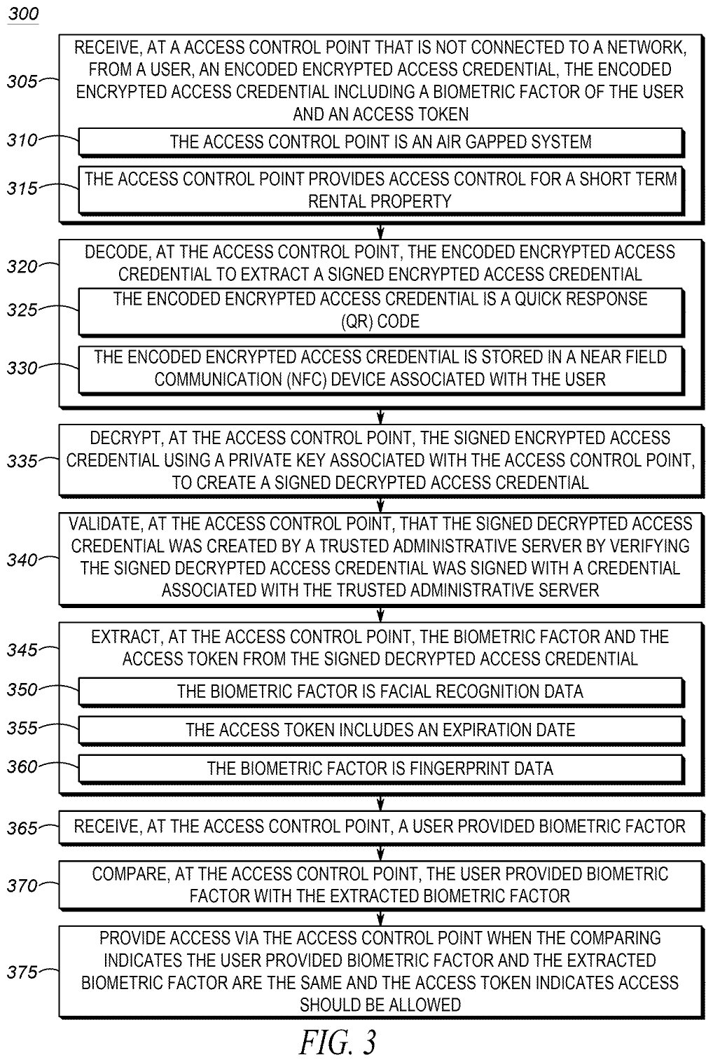

FIG. 3 is an example flow diagram 300 for an access control point that provides two-factor authentication for a user via an encoded encrypted access credential while not being connected to a network. In block 305, an encoded encrypted access credential is received from a user at an access control point that is not connected to a network. The encoded encrypted access credential including a biometric factor of the user and an access token. As explained above, the biometric factor is a biometric factor that may be used by the access control point to determine that the user presenting the encoded encrypted access credential is the same user that was provided the credential by the trusted administrative server. The access token is used to determine under what conditions the user is to be allowed access to the resource controlled by the access control point.

In block 310, the access control point is an air gapped system. As explained above, one possible use case for the techniques described herein is in implementations where the access control point is prohibited from being connected to any type of network. As such it is impossible for the access control point to communicate with the access control system to verify if a user has provided a valid access token and to verify the identity of the user via a biometric factor. In block 315, the access control point provides access control for a short term rental property. In some cases, the access control point may provide protection to a resource such as a short term rental property that does not have any network connectivity. The techniques described herein allow for the rental property owner to grant access to the property without having to actually go to the rental property to provide the required credentials to the access control point.

In block 320, the encoded encrypted access credential is decoded to extract a signed encrypted access credential. The encrypted access credential is encoded by the trusted administrative server in such a way that it can be conveniently provided to the user and that the user can provide the encoded encrypted access credential to the access control point.

In block 325, the encoded encrypted access credential is a Quick Response (QR) code. As explained above, encoding the encrypted access credential in a QR code allows the user to simply take a picture of the QR code with their device 9e.g. smartphone, etc.). The QR code can then be presented to the access control point by simply displaying the picture of the QR code. In block 330, the encoded encrypted access credential is stored in a Near Field Communication (NFC) device associated with the user. In many cases, smartphones can be programed to provide information via NFC. For example, credit card information can be stored in the phone and then provided via NFC technology, such as RFID or Bluetooth. Similarly, the encrypted access credential can be stored in a user device such that it can be provided to the access control point via NFC.

In block 335, the signed encrypted access credential is decrypted at the access control point using a private key associated with the access control point, to create a signed decrypted access credential. By using a private key associated with the access control point, it can be ensured that the signed encrypted access credential was intended for this particular access control point. If it was not, attempting to decrypt the signed encrypted access credential with the private key associated with the access control point would fail.

In block 340, it is validated, at the access control point, that the signed decrypted access credential was created by a trusted administrative server. This verification is done by verifying the signed decrypted access credential was signed with a credential associated with the trusted administrative server. As explained above, there are several ways that such a validation can be done (e.g. via certificate, via public/private key encryption, etc.). What should be understood is that the signed decrypted access credential is validated as having come from the trusted administrative server and that it has not been tampered with at any point after its creation.

In block 345, the biometric factor and the access token is extracted at the access control point from the signed decrypted access credential. Based on the previous steps, the access control point can be assured that the decrypted access credential was actually created by the trusted administrative server and that it has not been tampered with. As such, the biometric factor and access token can be trusted.

In block 350, the biometric factor is facial recognition data. As explained above, facial recognition is only one form of biometric factor that may be used. The techniques described herein are suitable for use with any type of biometric factor. In block 355, the access token includes an expiration date. The access token includes conditions under which a user who has been properly verified via a biometric factor is to be granted access via the access control point. In some cases, the access token may simply include an expiration date, after which the user is no longer allowed access. It should be understood that there are no limits on the type of criteria that may be included in the access token. In block 360, the biometric factor is fingerprint data. Once again, the techniques described herein are not limited to any particular type of biometric factor.

In block 365, a user provided biometric factor is received at the access control point. The user provides a biometric factor to the access control point in order for the access control point to determine if the user who was present when the access credential was created is actually the user who is now presenting the access credential.

In block 370, the user provided biometric factor is compared with the extracted biometric factor. The user provided biometric factor is definitively associated with the user because it is being received directly from the user. Based on the previous steps, the extracted biometric factor is confirmed as having been captured when the access credential was created, because if it wasn't at least one of the previous steps would have resulted in failure.

In block 375, access via the access control point is provided when the comparing indicates the user provided biometric factor and the extracted biometric factor are the same and the access token indicates access should be allowed. In other words if the comparison shows that the user present at the access control point is the same user that was present when the access credential was created, the two users are truly the same. If the access token indicates that verified user should be given access to via the access control point, then the user is granted access.

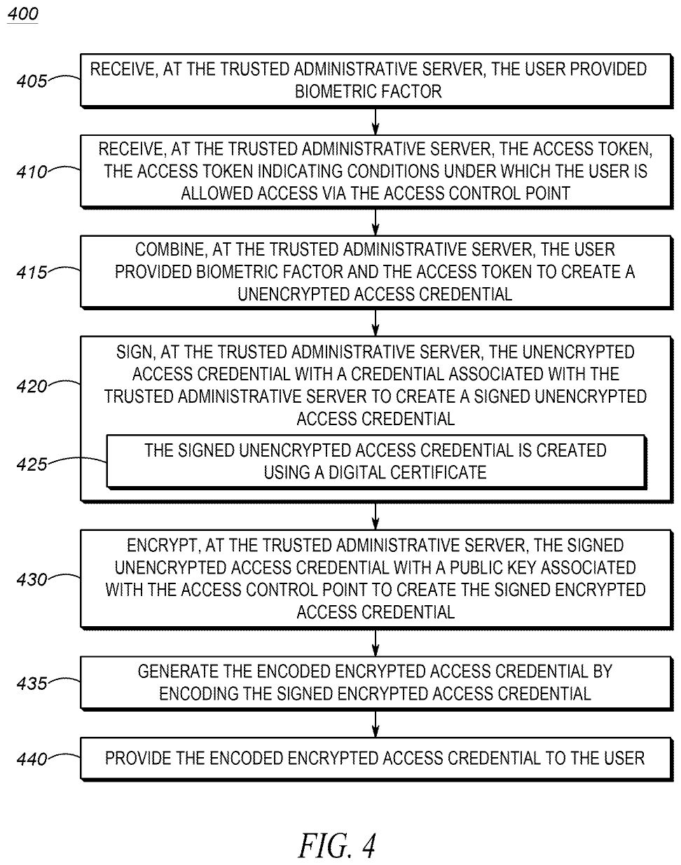

FIG. 4 is an example flow diagram 400 of an administrative server creating an encoded encrypted access credential. In block 405, the user provided biometric factor is received at the trusted administrative server. As part of the process, the user provides a biometric factor that will later be used to prove to the access control point that the user who was present at the trusted administrative server is the same user who is presenting themselves to the access control point.

In block 410, the access token is received at the trusted administrative server. The access token indicates the conditions under which the user is allowed access via the access control point. In many implementations, the access token will be created by the trusted administrative server. The access token determines under what conditions the user is to be granted access via the access control points. The access token can include information such as times of day, days of week, dates, etc. The access token is used to determine when a user who has been properly identified via a biometric factor is to be granted access.

In block 415, the user provided biometric factor and the access token are combined at the trusted administrative server to create an unencrypted access credential. At his point, there is no protection for the unencrypted access credential. Either the biometric factor or the access token could be altered, and there would be no way to detect such alteration.

In block 420, the unencrypted access credential is signed at the trusted administrative server with a credential associated with the trusted administrative server to create a signed unencrypted access credential. In other words, the unencrypted access credential is signed in such a way that if the unencrypted access credential is tampered with, such tampering can be detected. If tampering is detected, the unencrypted access credential may be discarded and no longer used to provide access.

In block 425, the signed unencrypted access credential is created using a digital certificate. Digital certificate may be used to verify that a something such as a signed unencrypted access credential has not been tampered with. Digital certificate signing utilizes various mechanisms, including hashes, to determine if tampering has occurred. If an tampering is done to the signed unencrypted access credential, the validation factors, such as the hash, would no longer match what was contained in the signature. It should be understood that signing with a digital certificate is one of many different ways the validity of the unencrypted access credential.

In block 430, the signed unencrypted access credential is encrypted at the trusted administrative server with a public key associated with the access control point to create the signed encrypted access credential. Encrypting the signed unencrypted access credential with a public key associated with the access control point ensures that only the access control point intended by the trusted administrative server is able to properly decrypt the signed encrypted access credential. This ensures that the signed encrypted access credential cannot be used at a different access control point other than the one that was intended, as no other access control point would have access to the correct private key.

In block 435, the encoded encrypted access credential is generated by encoding the signed encrypted access credential. The techniques described herein are not limited to any particular type of encoding. For example, the encoding may be in the form of a QR code provided to the user. The encoding may be provided to the user in a format that can be utilized by NFC on the user's device.

In block 440, the encoded encrypted access credential is provided to the user. The method through which it is provided to the user is dependent on the encoding technique. For example, in the case of a QR code, the trusted administrative server may display the QR code and the user takes a picture with their device (e.g. smartphone camera, etc.). As another example, the QR code could be sent as an image to the user device. In the case where the credential is encoded for use with NFC, the credential may be provided to the users device such that the credential can be successfully transmitted to the access control point via NFC. What should be understood is that the encoded encrypted access credential is provided to the user in such a way that it can be provided to the access control point.

Based on the description above, what should be understood is that the access control point can provide two-factor authentication (e.g. biometric factor and access token) without having any connection to the trusted administrative server (e.g. the access control system). Thus, the access control point can be completely isolated and yet still provide access without contact with the central access control system.

FIG. 5 is an example of a device that may implement the access control point and/or the trusted administrative server. It should be understood that FIG. 5 represents one example implementation of a computing device that utilizes the techniques described herein. Although only a single processor is shown, it would be readily understood that a person of skill in the art would recognize that distributed implementations are also possible. For example, the various pieces of functionality described above (e.g. creating the access credential using the access credential, etc.) could be implemented on multiple devices that are communicatively coupled. FIG. 5 is not intended to imply that all the functionality described above must be implemented on a single device.

Device 500 may include processor 510, memory 520, non-transitory processor readable medium 530, biometric factor interface 540, and video access control interface 550.

Processor 510 may be coupled to memory 520. Memory 520 may store a set of instructions that when executed by processor 510 cause processor 510 to implement the techniques described herein. Processor 510 may cause memory 520 to load a set of processor executable instructions from non-transitory processor readable medium 530. Non-transitory processor readable medium 530 may contain a set of instructions thereon that when executed by processor 510 cause the processor to implement the various techniques described herein.

For example, medium 530 may include trusted administrative server instructions 531. The trusted administrative server instructions 531 may cause the processor to implement the functionality described in FIGS. 1 and 4. For example, the trusted administrative server instructions 531 may utilize the biometric factor interface to obtain a biometric factor from a user. The type of interface is dependent on the type of biometric factor. For example, a facial biometric factor may use a camera, a fingerprint biometric factor may use a fingerprint scanner, and a DNA biometric may use a DNA sequencer.

The trusted administrative server instructions 531 may create the access token and cause the access token to be combined with the biometric factor. The combined biometric factor and access token can be signed and encrypted as described above. The trusted administrative server instructions 531 are described throughout the specification generally, including places such as the description of blocks 405-440.

The medium 530 may include access control point instructions 532. The access control point instructions 532 may cause the processor to implement the functionality described in FIGS. 2 and 3. For example, the access control point instructions 532 may cause the processor to utilize the access control point interface 550 to retrieve an encoded access credential from the user. The access control point instructions 532 may also cause the processor to retrieve a biometric from the user via the biometric factor interface.

The access control point instructions 532 may cause the processor to decrypt, validate, and extract the biometric factor and access token from the encoded access credential. The processor may compare the extracted biometric factor with the retrieved biometric factor. If the comparison indicates they are the same, the access control point instructions 532 may cause the processor to determine if the access token indicates if access should be granted. If so, the processor may utilize the access control interface 550 to grant access to the protected resource. The access control point instructions 532 are described throughout the specification generally, including places such as the description of blocks 305-375.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (Saas), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

As should be apparent from this detailed description above, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., and cannot encrypt/decrypt access tokens and biometric information using public/private key cryptography, digitally sign/validate an unencrypted access credential, capture/compare biometric identifiers, among other features and functions set forth herein).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if embodiments described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for two-factor authentication comprising:
receiving, at an access control point that is not connected to a network, from a user, an encoded encrypted access credential, the encoded encrypted access credential including a biometric factor of the user and an access token;
decoding, at the access control point, the encoded encrypted access credential to extract a signed encrypted access credential;
decrypting, at the access control point, the signed encrypted access credential using a private key associated with the access control point, to create a signed decrypted access credential;
validating, at the access control point, that the signed decrypted access credential was created by a trusted administrative server by verifying the signed decrypted access credential was signed with a credential associated with the trusted administrative server;
extracting, at the access control point, the biometric factor and the access token from the signed decrypted access credential;
receiving, at the access control point, a user provided biometric factor;
comparing, at the access control point, the user provided biometric factor with the extracted biometric factor; and
providing access via the access control point when the comparing indicates the user provided biometric factor and the extracted biometric factor are the same and the access token indicates access should be allowed.

2. The method of claim 1 further comprising:
receiving, at the trusted administrative server, the user provided biometric factor;
receiving, at the trusted administrative server, the access token, the access token indicating conditions under which the user is allowed access via the access control point;
combining, at the trusted administrative server, the user provided biometric factor and the access token to create a unencrypted access credential;
signing, at the trusted administrative server, the unencrypted access credential with a credential associated with the trusted administrative server to create a signed unencrypted access credential;
encrypting, at the trusted administrative server, the signed unencrypted access credential with a public key associated with the access control point to create the signed encrypted access credential;
generating the encoded encrypted access credential by encoding the signed encrypted access credential; and
providing the encoded encrypted access credential to the user.

3. The method of claim 2 wherein the signed unencrypted access credential is created using a digital certificate.

4. The method of claim 1 wherein the encoded encrypted access credential is a Quick Response (QR) code.

5. The method of claim 1 wherein the encoded encrypted access credential is stored in a Near Field Communication (NFC) device associated with the user.

6. The method of claim 1 wherein the biometric factor is facial recognition data.

7. The method of claim 1 wherein the biometric factor is fingerprint data.

8. The method of claim 1 wherein the access token includes an expiration date.

9. The method of claim 1 wherein the access control point is an air gapped system.

10. The method of claim 1 wherein the access control point provides access control for a short term rental property.

11. A system for two-factor authentication comprising:
a processor; and
a memory coupled to the processor, the memory containing a set of instructions thereon that when executed by the processor cause the processor to:
receive, at an access control point that is not connected to a network, from a user, an encoded encrypted access credential, the encoded encrypted access credential including a biometric factor of the user and an access token;
decode, at the access control point, the encoded encrypted access credential to extract a signed encrypted access credential;
decrypt, at the access control point, the signed encrypted access credential using a private key associated with the access control point, to create a signed decrypted access credential;
validate, at the access control point, that the signed decrypted access credential was created by a trusted administrative server by verifying the signed decrypted access credential was signed with a credential associated with the trusted administrative server;
extract, at the access control point, the biometric factor and the access token from the signed decrypted access credential;
receive, at the access control point, a user provided biometric factor;
compare, at the access control point, the user provided biometric factor with the extracted biometric factor; and
provide access via the access control point when the comparing indicates the user provided biometric factor and the extracted biometric factor are the same and the access token indicates access should be allowed.

12. The system of claim 11 further comprising instructions that cause the processor to:
receive, at the trusted administrative server, the user provided biometric factor;
receive, at the trusted administrative server, the access token, the access token indicating conditions under which the user is allowed access via the access control point;
combine, at the trusted administrative server, the user provided biometric factor and the access token to create a unencrypted access credential;
sign, at the trusted administrative server, the unencrypted access credential with a credential associated with the trusted administrative server to create a signed unencrypted access credential;
encrypt, at the trusted administrative server, the signed unencrypted access credential with a public key associated with the access control point to create the signed encrypted access credential;
generate the encoded encrypted access credential by encoding the signed encrypted access credential; and
provide the encoded encrypted access credential to the user.

13. The system of claim 11 wherein the encoded encrypted access credential is a Quick Response (QR) code.

14. The system of claim 11 wherein the encoded encrypted access credential is stored in a Near Field Communication (NFC) device associated with the user.

15. The system of claim 11 wherein the access control point provides access control for a short term rental property.

16. A non-transitory processor readable medium containing a set of instructions thereon that when executed by a processor cause the processor to:
receive, at an access control point that is not connected to a network, from a user, an encoded encrypted access credential, the encoded encrypted access credential including a biometric factor of the user and an access token;
decode, at the access control point, the encoded encrypted access credential to extract a signed encrypted access credential;
decrypt, at the access control point, the signed encrypted access credential using a private key associated with the access control point, to create a signed decrypted access credential;
validate, at the access control point, that the signed decrypted access credential was created by a trusted administrative server by verifying the signed decrypted access credential was signed with a credential associated with the trusted administrative server;
extract, at the access control point, the biometric factor and the access token from the signed decrypted access credential;
receive, at the access control point, a user provided biometric factor;
compare, at the access control point, the user provided biometric factor with the extracted biometric factor; and
provide access via the access control point when the comparing indicates the user provided biometric factor and the extracted biometric factor are the same and the access token indicates access should be allowed.

17. The non-transitory processor readable medium of claim 16 further comprising instructions that cause the processor to:
receive, at the trusted administrative server, the user provided biometric factor;
receive, at the trusted administrative server, the access token, the access token indicating conditions under which the user is allowed access via the access control point;
combine, at the trusted administrative server, the user provided biometric factor and the access token to create a unencrypted access credential;
sign, at the trusted administrative server, the unencrypted access credential with a credential associated with the trusted administrative server to create a signed unencrypted access credential;
encrypt, at the trusted administrative server, the signed unencrypted access credential with a public key associated with the access control point to create the signed encrypted access credential;
generate the encoded encrypted access credential by encoding the signed encrypted access credential; and
provide the encoded encrypted access credential to the user.

18. The non-transitory processor readable medium of claim 16 wherein the encoded encrypted access credential is a Quick Response (QR) code.

19. The non-transitory processor readable medium of claim 16 wherein the encoded encrypted access credential is stored in a Near Field Communication (NFC) device associated with the user.

20. The non-transitory processor readable medium of claim 16 wherein the access control point provides access control for a short term rental property.
